(19) United States
(12) Patent Application Publication
(10) Pub. No.: US 2012/0276391 A1
(43) Pub. Date: Nov. 1, 2012

(54) FIRE-RETARDANT POLYAMIDE CAST ITEM INCLUDING AN INTUMESCENT COATING

(75) Inventors: Helene Gallou, Vermelles (FR); Maude Jimenez, Lille (FR); Charafeddine Jama, Villeneuve D'ascq (FR); Sophie Duquesne, Saint-andre-lez-lille (FR); Rene Delobel, Villeneuve D'ascq (FR); Xavier Couillens, Lyon (FR); Serge Bourbigot, Villeneuve D'ascq (FR)

(73) Assignee: RHODIA OPERATIONS, Aubervilliers (FR)

(21) Appl. No.: 13/502,074

(22) PCT Filed: Oct. 15, 2010
(86) PCT No.: PCT/EP2010/065553

§ 371 Date: Jul. 9, 2012

(30) Foreign Application Priority Data
Oct. 16, 2009 (FR) 0957259

(51) Int. Cl. B32B 27/34; B32B 27/30; B32B 23/08

(52) U.S. Cl. 428/413; 428/474.4; 428/479.3; 428/476.3; 428/423.5

(57) ABSTRACT

Fire-retardant polyamide cast items including an intumescent coating are described. The case items can have excellent fire-retardant properties and can include at least one fire-retardant system in the polyamide matrix. The items can also have an intumescent coating on at least one surface.

The present invention relates to polyamide-based flame-retardant molded articles comprising an intumescent coating. These articles, which exhibit excellent flame-retardant properties, comprise, in the polyamide matrix, at least one flame-retardant system and exhibit an intumescent coating over at least one of the surfaces of said molded articles.

### PRIOR ART

Compositions based on polyamide resin are used to produce articles by various forming processes denoted by the generic term “molding”. These articles are used in numerous technical fields. Among these, the production of components of electrical or electronic systems is a major application requiring specific properties. Thus, these components have to exhibit superior mechanical properties but also properties of chemical resistance and electrical insulation and especially a high resistance to fire.

The flame retardancy of compositions based on polyamide resin has been studied for a very long time. Thus, the main flame retardants used are red phosphorus and halogenated compounds, such as dibromophenols, polybromodiphenyls, polybromodiphenyl oxides and brominated polystyrenes. From about twenty years ago, new flame-retardant categories have been developed, such as nitrogenous organic compounds belonging to the category of the triazines, such as melamine or its derivatives, such as melamine cyanurate and more recently melamine phosphates, polyphosphates and pyrophosphates, alone or in combination with organic and/or inorganic phosphonates or phosphinates.

The advantage of this final category of flame retardants lies in the fact that the compounds concerned do not comprise halogens or red phosphorus. This is because flame retardants comprising halogens or red phosphorus can generate toxic gases during the combustion of the polyamide composition or even during the preparation of said composition. However, the amounts of some melamine-based compounds necessary to obtain satisfactory flame retardancy are very high, in particular for the compositions comprising reinforcing fillers in the form of fibers, such as glass fibers. This high concentration of melamine compounds exhibits certain disadvantages, in particular during the manufacture of the composition, such as the production of vapor of the melamine-comprising compounds, or during the production of molded articles, such as the blocking of the ventilation pipes and deposits in the molds.

Likewise, the new organic phosphorus-based flame-retardant systems are high in cost and need to be used in a large amount in order to obtain good flame retardancy properties.

An excessively high amount of flame-retardant agents in a polyamide matrix furthermore results in a deterioration in its mechanical properties.

There thus exists a need to prepare flame-retardant polyamide compositions comprising contents of flame-retardant agents, in particular organophosphorus compounds, which are relatively low or, in any case, significantly lower than the content normally used to obtain a good flame retardancy capability.

### INVENTION

The Applicant Company has shown, entirely unexpectedly, that it is possible to produce polyamide articles exhibiting excellent flame retardancy properties, while using small amounts of flame-retardant agents, by carrying out an intumescent coating of said polyamide articles.

The present invention thus relates to articles based on polyamide rendered flame-retardant by a flame retardancy system and comprising an intumescent coating.

A subject matter of the present invention is thus a flame-retardant article obtained by forming a polyamide composition comprising at least one flame retardancy system, said article comprising, at least over a portion of its surface, an intumescent coating.

Intumescent coating is understood to mean, within the meaning of the invention, a coating of a material, the distinctive feature of which lies in an expansion of said coating in the presence of heat exceeding a certain temperature. This material thus exhibits, inter alia, properties of delaying the propagation of the combustion.

Surface is understood to mean the surface layer of a polyamide article according to the invention. A surface is generally a portion defined by a border or boundaries. A surface can in particular be flat, concave and/or convex, depending on the articles and their complexity.

Polyamide

The article according to the invention is obtained by forming a polyamide-based composition, that is to say a composition comprising at least one polyamide.

The polyamide is chosen from the group consisting of polyamides obtained by polycondensation of a linear dicarboxylic acid with a linear or cyclic diamine, such as PA 6.6, PA 6.10, PA 6.12, PA 12.12, PA 4.6 or MXD 6, or between an aromatic dicarboxylic acid and a linear or aromatic diamine, such as polyterephthalamides, polyisophthalamides or polyaramids, and polyamides obtained by polycondensation of an amino acid on itself, it being possible for the amino acid to be generated by the hydrolytic opening of a lactam ring, such as, for example, PA 6, PA 7, PA 11 or PA 12.

The composition of the invention can also comprise copolyamides derived in particular from the above polyamides, or the blends of these polyamides or copolyamides.

The preferred polyamides are poly(hexamethylene adipamide), polycaprolactam, or the copolymers and blends between poly(hexamethylene adipamide) and polycaprolactam.

Use is generally made of polyamides with molecular weights suited to injection molding processes, although it is also possible to use polyamides having lower viscosities. Use may also be made of polyamides having higher molecular weights, in particular as regards transformation processes of extrusion or extrusion/blow molding type.

The polyamide matrix can in particular be a polymer comprising star or H macromolecular chains and, if appropriate, linear macromolecular chains. Polymers comprising such star or H macromolecular chains are described, for example, in the documents FR 2 743 077, FR 2 779 730, US 5 959 069, EP 0 632 703, EP 0 682 057 and EP 0 832 149.

According to another specific alternative form of the invention, the polyamide matrix of the invention can be a polymer of random tree type, preferably a copolyamide exhibiting a random tree structure. These copolyamides with a random tree structure and their process for preparation are described in particular in the document WO 99/03909. The matrix of the invention can also be a composition comprising a linear thermoplastic polymer and a star, H and/or tree thermoplastic polymer as are described above. The matrix of the invention can also comprise a hyperbranched copolyamide of the type of those described in the document WO 00/68298. The composition of the invention can also comprise any combination of linear, star, H and tree thermoplastic polymer and hyperbranched copolyamide as described above.

The composition according to the invention can comprise between 20 and 99% by weight, preferably between 20 and 80% by weight and more preferably between 50 and 70% by weight of polyamide, with respect to the total weight of the composition.

The matrix of the composition can also comprise, in addition to the polyamide, one or more other polymers, in particular thermoplastic polymers.

The composition can also comprise reinforcing fillers chosen in particular from the group consisting of glass fibers, inorganic fillers, such as kaolin, talc or wollastonite, and exfoliable fillers. The concentration by weight of the reinforcing fillers is advantageously between 1 and 50% by weight, with respect to the total weight of the composition, preferably between 15 and 50% by weight. Use may in particular be made of a mixture of glass fibers and inorganic fillers, such as wollastonite.

The compositions of the invention can also comprise any additive normally used in polyamide-based compositions used for the manufacture of molded articles. Thus, mention may be made, as examples of additives, of heat stabilizers, U.V. stabilizers, antioxidants, lubricants, pigments, dyes, plasticizers or agents which modify the impact strength. By way of example, the antioxidants and heat stabilizers are, for example, alkali metal halides, copper halides, sterically hindered phenolic compounds or aromatic amines. The U.V. stabilizers are generally benzotriazoles, benzophenones or HALSs.

There is no limitation on the types of agents which modify the impact strength. It is generally the elastomeric polymers which can be used for this purpose. Examples of suitable elastomers are ethylene/acrylic ester/maleic anhydride polymers, ethylene/propylene/maleic anhydride polymers or EPDM (ethylene/propylene/diene monomer) polymers with optionally a grafted maleic anhydride. The concentration by weight of elastomer is advantageously between 0.1 and 15%, with respect to the total weight of the composition.

The compositions of the invention are obtained by mixing the various constituents, generally in a single- or twin-screw extruder, at a temperature sufficient to keep the polyamide resin as a molten medium. Generally, the mixture obtained is extruded in the form of rods which are cut into pieces in order to form granules.

The flame-retardant agents can be added, together or separately, to the polyamide by mixing under hot conditions or under cold conditions.

The addition of the compounds and additives can be carried out by addition of these compounds to the molten polyamide in the pure form or in the form of a concentrated mixture in a resin, such as, for example, a polyamide resin.

The granules obtained are used as starting material to feed processes for the manufacture of articles, such as injection, injection molding, extrusion and extrusion/blow molding processes.

The article according to the invention can in particular be an extruded or injected article.

Thus, the composition of the invention is particularly suitable for the manufacture of articles used in the field of electrical or electronic connections, such as components of circuit breakers, switches, connectors or the like.

Flame-Retardant Agents in the PA Matrix:

The flame retardancy system according to the present invention can comprise flame-retardant agents of any type, that is to say compounds which make it possible to reduce flame propagation and/or which have flame retardancy properties, which are well known to a person skilled in the art. These flame-retardant agents are generally used in flame-retardant compositions and are described in particular, for example, in patents U.S. Pat. No. 6,344,158, U.S. Pat. No. 6,365,071, U.S. Pat. No. 6,211,402 and U.S. Pat. No. 6,255,371, cited here by way of reference.

Advantageously, the flame retardancy system comprises at least one flame-retardant agent chosen from the group consisting of:
phosphorus-comprising flame-retardant agents, such as:
phosphine oxides, such as, for example, triphenylphosphine oxide, tri(3- and brominated polystyrene), poly(pentabromobenzyl acrylate), brominated indane, tetradecabromodiphenoxybenzene (Saytex 120), 1,2-bis(pentabromophenyl)ethane or Saytex 8010 from Albemarle, tetrabromobisphenol A and brominated epoxy oligomers. Mention may in particular be made, among brominated derivatives, of polydibromostyrene, such as PDBS-80 from Chemtura, brominated polystyrenes, such as Saytex HP 3010 from Albemarle or FR-803P from Dead Sea Bromine Group, decabromodiphenyl ether (DBPE) or FR-1210 from Dead Sea Bromine Group, octabromodiphenyl ether (OBPE), 2,4,6-tris(2,4,6-tribromophenoxy)-1,3,5-triazine or FR-245 from Dead Sea Bromine Group, poly(pentabromobenzyl acrylate) or FR-1025 from Dead Sea Bromine Group, and oligomers or polymers comprising epoxy endings of tetrabromobisphenol A, such as F-2300 and F2400 from Dead Sea Bromine Group,
chlorinated compounds, such as, for example, a chlorinated cycloaliphatic compound, such as Dechlorane Plus® (sold by OxyChem, see CAS 13560-89-9).

These compounds can be used alone or in combination, sometimes synergistically. Preference is given in particular to a synergistic combination of phosphorus-comprising compounds, such as phosphine oxides, phosphonic acids or their salts or phosphinic acids or their salts, and cyclic phosphonates, with nitrogenous derivatives, such as melam, melem, melamine phosphate, melamine polyphosphates, melamine pyrophosphates or ammonium polyphosphates.

The composition can comprise from 5 to 40% by weight of flame-retardant agents, with respect to the total weight of the composition.
hydroxypropyl)phosphine oxide and tri(3-hydroxy-2-methylpropyl)phosphine oxide,
phosphonic acids and their salts and phosphinic acids and their salts, such as, for example, zinc, magnesium, calcium, aluminum or manganese salts of phosphinic acids, in particular the aluminum salt of diethylphosphinic acid or the zinc salt of dimethylphosphinic acid,
cyclic phosphonates, such as cyclic diphosphonate esters, such as, for example, Antiblaze 1045,
organic phosphates, such as triphenyl phosphate,
inorganic phosphates, such as ammonium polyphosphates and sodium polyphosphates,
red phosphorus, whether, for example, in the stabilized or coated form, as a powder or in the form of masterbatches,
flame-retardant agents of nitrogenous organic compound type, such as, for example, triazines, cyanuric acid and/or isocyanuric acid, melamine or its derivatives, such as melamine cyanurate, oxalate., phthalate, borate, sulfate, phosphate, polyphosphate and/or pyrophosphate, products condensed from melamine, such as melem, melam and melon, tri(hydroxyethyl) isocyanurate, benzoguanamine, guanidine, allantoin and glycoluril,
flame-retardant agents comprising halogenated derivatives, such as:
bromine derivatives, such as, for example, PBDPOs (polybromodiphenyl oxides), BrPS (polybromostyrene

### Intumescent Coating

Intumescent coatings are products, the distinctive feature of which lies in their transformation with regard to heat. Under cold conditions, the thickness of the film generally varies from 0.1 to 4 mm. Brought to a temperature of between 180° C. and 300° C., the product swells and is transformed into a foam, generally reaching thicknesses of 30 to 40 mm. These coatings are employed according to conventional methods used in the field, in particular via guns or brushes, but require great precision in their application phase in order to make sure that the protection is homogeneous. The preservation of an attractive appearance is the main advantage of this type of protection, which can achieve protection times of one hour, indeed even, for some solutions, of one and a half hours to two hours. Intumescent coatings also exhibit advantageous durability properties and can be used internally or externally. Because of these various advantages and of changes in regulations, intumescent coatings are experiencing major developments.

Virtually all intumescent coatings sold for metal structures, which are also suitable for the present invention, are composed of four main components:
the acid source: a compound capable of releasing an acid, such as, for example, phosphoric acid, when it is subjected to a rise in temperature. Ammonium polyphosphate (APP) or melamine phosphates are generally used,
the carbon source: an organic compound comprising hydroxyl groups capable of reacting with the acid, such as, for example, hydroxyl groups, typically pentaerythritol,
the blowing agent: a compound which releases, under the action of heat, a large amount of nonflammable gases which bring about the expansion of the phosphorus/carbon structure, such as, for example, melamine,
and, finally, the binder: a substance, generally a liquid substance, in or not in combination with a solvent, which traps the particles of pigments or of additives and forms a solid film after drying. This substance can in particular be an acrylic or epoxy resin, for example. The binder is the base element of the coating which allows it to be characterized.

The intumescent coating can be chosen from the group consisting of: aqueous coatings, glycero coatings, cellulose coatings, vinyl coatings, acrylic coatings, polyurethane coatings and epoxy coatings.

The coating used according to the invention is preferably a paint or a varnish; such as, for example, a soft, aqueous-based, matt, transparent, intumescent varnish having good adhesion with the polymeric matrix.

It is generally accepted that the mechanism resulting in the development of the intumescence is as follows. In a first step, the acid source decomposes under the action of an increase in temperature, releasing, for example, phosphoric acid, which reacts with the carbon source agent to form phosphate esters and water. These esters subsequently decompose and result in the formation of a phosphorus/carbon structure, more generally referred to as char. Since these reactions take place at temperatures above 100° C., the water released is immediately transformed into steam. This steam, and the gases from the decomposition of the blowing agent, transform the phosphorus/carbon structure into a foam. The binder will help in trapping the decomposition gases and will have a significant effect on the degree of expansion and on the size of the cells of which the foam is composed and thus on the fire-resistance performance of the intumescent structure.

The adhesion between the surface to be treated of the article and the intumescent coating is an important point to be considered. Generally, the mechanical adhesion model is distinguished from the specific adhesion models, which all cover phenomena other than pure mechanical anchoring. Singled out among the latter are the theory of diffusion, and the theory of thermomechanical adsorption, or theory of wetting. There also exist electrical or chemical adhesion models.

The mechanical adhesion results from a mechanical anchoring in the pores and bumps of the substrate. The adhesion by diffusion results from the interdiffusion of the molecules of the surface planes, which is reflected by the creation of a transition region known as thick interphase or interface. The adhesion by interdiffusion is based on two fundamental criteria: a thermodynamic criterion: the macromolecules have to be mutually soluble or compatible, and a kinetic criterion: the macromolecules have to exhibit a sufficient mobility, hence the importance of the temperature. When these two conditions are combined, interpenetration of the macromolecular chains occurs. The force necessary to bring about rupture is proportional, on the one hand, to the number of chains which have passed across the interface and, on the other hand, to the mean depth of penetration of the macromolecules. This theory is definitely confirmed in the case of the adhesion of compatible polymers, for example.

The theory of wetting was introduced by Sharpe and Schonhorn. According to this theory, the adhesion is attributed to intermolecular forces of Van der Waals type existing at the interface. These intermolecular bonds are weak and undirected. They have a field of action of the order of the intermolecular distances. For this reason, in order for them to become established, it is necessary to bring about intimate contact between the two surfaces. Generally, the criterion for good adhesion is essentially a wettability criterion.

In order to increase the adhesion between the surface to be treated of the article and the intumescent coating, it is posible to treat the surface beforehand by plasma treatment or by flame treatment, for example. The substrate can in particular be treated beforehand by flame treatment in order to increase the quality of adhesion of the intumescent coating of paint or varnish type to the polymer. The flame treatment consists in exposing the surface to be treated to thermal oxidation; an oxidizing flame is created during the combustion of a hydrocarbon. The optimized parameters for flame treatment are, for example: a distance between the flame and the surface of 8.8 cm, a speed of the flame treatment rig of 200 m/s, three passes of the sample in front of the flame and the use of methane as combustion gas.

Mention may in particular be made, as intumescent coatings, of the following products:
FX-100 ® from Flame Seal Products
Nullifire (for example, S607—paint)
Unitherm 19010—varnish
A650P—Comus varnish
Char 17—varnish from Iris Vernici s.r.l., Italy
Firesteel from Firetherm Intumescent and Insulation Supplies Ltd., Kent, United Kingdom;
Firetex from Altex Coatings Ltd., Bay of Plenty, New Zealand;
A/D Firefilm® from AD Fire Protection Systems Ltd., Ontario, Canada;
Taikalitt from Nippon Paint Company, Osaka, Japan;
Safecoat Products from Eagle Specialized Coatings and Protected Environments, Division of DW Pearce Enterprises Ltd., British Columbia, Canada.

The intumescent coatings are applied over at least a portion of the surface of the article according to the invention. The coating will in particular be applied to the portions of the surface which will be liable to be in contact with strong heat, in particular flames.

It is preferable in particular to use intumescent coatings not comprising a flame-retardant agent, such as those which can be used in bulk in the polyamide composition of the invention.

The present invention also relates to a process for the manufacture of a flame-retardant article, in which an intumescent coating is applied over at least a portion of the surface of the article, after having optionally carried out a stage of treatment of the surface in order to increase the adhesion between the surface and the coating.

A specific language is used in the description so as to facilitate understanding of the principle of the invention. Nevertheless, it should be understood that no limitation on the scope of the invention is envisioned by the use of this specific language. Modifications and improvements can in particular be envisioned by a person conversant with the technical field concerned on the basis of his own general knowledge.

The term “and/or” includes the meanings “and”, “or” and all the other possible combinations of the elements connected to this term.

Other details or advantages of the invention will become more clearly apparent in the light of the examples given below solely by way of indication.

Experimental Part

Materials Used

The tests were carried out on virgin polyamide 6,6, polyamide 6,6 charged with 2% of intercalated silicate nanofillers (Nanofil SE3010 from Sud-Chemie), polyamide 6,6 charged with 30% of glass fibers (Vetrotex 983) and polyamide 6,6 charged with 30% of glass fibers and 2% of nanofillers.

Flame-retardant agents were added to some formulations:
FR1: aluminum phosphinate (OP 1230 from Clariant)
FR2: 1,2-bis(pentabromophenyl)ethane (Saytex 8010 from Albemarle)

3 types of coatings were used: an intumescent paint, Nullifire S607HB (Nullifire), and two intumescent varnishes, A650P (SEPV-Comus) and Pyroplast HW (Rustifrance).

Procedure for Depositing the Coatings

The deposition procedure takes place in two stages: a pretreatment and a deposition stage. The substrate is treated beforehand by a flame treatment at a temperature of the order of 1000° C. in order to enhance the quality of adhesion of the intumescent coating to the polymer during the following stage. The flame treatment consists in exposing the surface to be treated to a thermal oxidation; an oxidizing flame is created during the combustion of a hydrocarbon. The flame treatment parameters optimized during preceding studies are: a distance between the flame and the surface of 8.8 cm, a speed of the flame treatment rig of 200 m/s, three passes of the sample in front of the flame and the use of methane as combustion gas.

The application of the intumescent coating is carried out using a brush or can be carried out by spraying.

The scratch test showed that the flame treatment makes it possible to improve the adhesion of the coatings to the polymer. This was observed in the cross hatch test using an Elcometer® 107 cutter. This test, which gives a qualitative assessment of the adhesion, consists in scratching the surface of the substrate using a cutter with six or eleven teeth separated by one millimeter, so as to trace out a cross hatch pattern of 25 or 100 squares, depending on the number of teeth of the cutter, with a size of 1 mm². A standardized piece of adhesive is subsequently applied to it, which piece of adhesive is removed after 90±30 seconds. Inspection of the cross-hatched surface after removing the adhesive makes it possible to classify the adhesive properties of the substrate as a function of the amount of coating torn off. The tests are carried out while observing the standard ASTM D 3359-02 “Standard Test Methods for Measuring Adhesion by Tape Test”.

Measurements of the Flame Retardancy Properties

The LOI (Limiting Oxygen Index), expressed as a percentage, and the UL94 test were carried out conventionally.

The glow wire test apparatus makes it possible to measure the GWFI (Glow Wire Flammability Index). The GWFI consists in simulating a thermal shock and in evaluating the risks of ignition and the self extinguishing capability of the fire generated by one and the same material. The method consists in applying the end of a heating and/or glow wire at a given temperature (550, 650, 750, 850, 960° C.) for 30 s to a 60 mm×60 mm test specimen with a given force of between 0.8 and 1.2 N and in measuring the extinguishing time of the flames after removing the wire.

The product is characterized by the temperature at which 3 consecutive test specimens self-extinguish in less than 30 s after removal of the glow wire.

During the test, the following must be recorded:
The time (tᵢ) from the beginning of the application of the end of the glow wire up to the moment when the test specimen or the underlayer specified catches fire.
The time (tₑ) from the beginning of the application of the end of the glow wire up to the moment when the flames extinguish, during or after the period of application.
The maximum height of any flame, without, however, taking into consideration the beginning of the occurrence of flames, which can produce a high flame for approximately 1 s.
Whether the test specimen passes the test because the larger part ignited is carried away with the glow wire.
Any occurrence of flames in the underlayer placed under the specimen (this requires that a new test be carried out on 3 new test specimens at a lower temperature).

The test specimen must be observed during the application of the glow wire. The ignition time (tᵢ), that is to say the time between the beginning of the application of the end of the wire and the time at which the test specimen bursts into flames, must be recorded.

The cone calorimeter is a device which makes it possible, inter alia, to access the change in the amount of heat given off by the combustion of the sample, the inflammability, the loss in weight, the opaqueness of the smoke and the levels of CO/CO₂ given off during the test. The sample is placed horizontally and is subjected to a controlled level of irradiance. The test is carried out in an open environment, in the presence of extractors. The samples are subjected, in ambient air, to a heat flux emitted by a truncated cone (heat flux of between 0 and 100 kW/m²), so as not to disturb the flame. The rate of heat release is evaluated following the principle of oxygen consumption calorimetry. Various analyzers coupled to this system make it possible to evaluate the loss in weight, the opaqueness of the smoke (extinction coefficient k) and the contents of CO and CO₂ during the combustion (infrared analyzers). The ignition time is measured by this test.

Results

The results of the tests are given in the following tables:

TABLE 1

| | LOI | LOI | UL94 | UL94 | GWFI | GWFI |
|---|---|---|---|---|---|---|
| | 0.8 | 1.6 | 0.8 | 1.6 | 0.8 | 1.0 |
| | mm | mm | mm | mm | mm | mm |
| C1: virgin | 20-21 | 20-21 | NC | NC | 650 | 650 |
| C2: GF | 20-21 | 21-22 | NC | NC | 650 | 650 |
| C3: Nano | 21-22 | 21-22 | NC | NC | 650 | 650 |
| C4: GF Nano | 21-22 | 22-23 | NC | NC | 650 | 650 |
| C5: GF + 23% FR1 | 41-42 | 43-44 | V0 | V0 | 960 | 960 |
| C6: GF + 18% FR1 | 37-38 | 39-40 | V1 | V1 | 960 | 960 |
| C7: GF + 15% FR1 | 36-37 | 37-38 | V1 | V1 | 960 | 960 |
| C8: GF + 12% FR1 | 33-34 | 35-36 | V1 | V1 | 960 | 960 |
| C9: GF + 10% FR1 | 33-34 | 34-35 | V1 | V1 | 960 | 960 |
| C10: GF + 8% FR1 | 29-30 | 32-33 | V1 | V1 | 960 | 960 |
| C11: GF + 5% FR1 | 26-27 | 27-28 | NC | NC | 850 | 850 |
| C12: A650P | 24-25 | 24-25 | NC | NC | 650 | 650 |
| C13: GF + A650P | 27-28 | 26-27 | NC | NC | 750 | 750 |
| C14: Nano + A650P | 24-25 | 25-26 | NC | NC | 650 | 650 |
| C15: GF Nano + A650P | 28-29 | 28-29 | NC | NC | 750 | 850 |
| C16: Nullifire | — | 30-31 | NC | NC | 650 | 650 |
| C17: GF + Nullifire | — | 40-41 | NC | NC | 650 | 650 |
| C18: Nano + | — | 40-41 | NC | NC | 650 | 650 |
| Nullifire | | | | | | |
| C19: GF Nano + | — | 42-43 | NC | NC | 750 | 850 |
| Nullifire | | | | | | |
| C20: 24% FR2 | — | — | V2 | V2 | — | — |

TABLE 2

| | LOI | LOI | UL94 | UL94 | GWFI | GWFI |
|---|---|---|---|---|---|---|
| | 0.8 | 1.6 | 0.8 | 1.6 | 0.8 | 1.0 |
| | mm | mm | mm | mm | mm | mm |
| 1. GF + 18% FR1 + | 40-41 | 42-43 | V0 | V0 | 960 | 960 |
| A650P | | | | | | |
| 2. GF + 12% FR1 + | 36-37 | 37-38 | V0 | V0 | 960 | 960 |
| A650P | | | | | | |
| 3. GF + 8% FR1 + | 33-34 | 33-34 | V0 | — | 960 | 960 |
| A650P | | | | | | |
| 4. GF + 5% FR1 + | 63-64 | 65-66 | V0 | V0 | 960 | 960 |
| Pyroplast HW | | | | | | |
| 5. 24% FR2 + | 64-65 | 69-60 | V0 | V0 | — | — |
| Pyroplast HW | | | | | | |

TABLE 3

| | Cone calorimeter |
|---|---|
| | Ignition time |
| | (without forced ignition |
| | with a panel with an |
| | irradiance of 50 kW/m²) |
| C1: virgin | 80 |
| C2: GF | 54 |
| C3: Nano | 53 |
| C4: GF Nano | 51 |
| C5: GF + 23% FR1 | 69 |
| C6: GF + 18% FR1 | 69 |
| C8: GF + 12% FR1 | 63 |
| C10: GF + 8% FR1 | 60 |
| 2. GF + 12% FR1 + A650P | 123 |
| 3. GF + 8% FR1 + A650P | 123 |
| 4: GF + 5% FR1 + Pyroplast HW | 219 |
| 6. GF + 23% FR1 + pyroplast HW | 318 |

It is thus observed that the flame-retardant articles of the invention, comprising an intumescent coating at least over a portion of their surfaces, exhibit much better flame retardancy properties in comparison with the flame-retardant polyamide compositions conventionally used.

1. A flame-retardant article comprising, on a portion of at least one surface, an intumescent coating, wherein the article further comprises a polyamide composition comprising at least one flame retardant system.

2. The article as defined by claim 1, wherein the composition additionally comprises reinforcing fillers.

3. The article as defined by claim 1, wherein the flame retardancy system of the polyamide composition comprises at least one phosphorus-comprising flame-retardant agent selected from the group consisting of: a phosphine oxide, a phosphonic or a salt thereof, a phosphinic acid or a salt thereof, a cyclic phosphonate, an organic phosphate, an inorganic phosphate and a red phosphorus.

4. The article as defined by claim 1, wherein the flame retardancy system of the polyamide composition comprises at least one flame-retardant agent of a nitrogenous organic compound selected from the group consisting of: a triazine, a cyanuric acid, an isocyanuric acid, a melamine, a melamine oxalate, a phthalate, a borate, a sulfate, a phosphate, a polyphosphate, a pyrophosphate, a product condensed from melamine, a tris(hydroxyethyl) isocyanurate, a benzoguanamine, a guanidine, an allantoin and a glycoluril.

5. The article as defined by claim 1, wherein the flame retardancy system of the polyamide composition comprises at least one flame-retardant agent comprising brominated derivatives selected from the group consisting of: a PBDPO (polybromodiphenyl oxide), a BrPS (polybromostyrene or brominated polystyrene), a poly(pentabromobenzyl acrylate), a brominated indane, a tetradecabromodiphenoxybenzene, a 1,2-bis(pentabromophenyl)ethane, a tetrabromobisphenol A and a brominated epoxy oligomer.

6. The article as defined by claim 1, wherein the composition comprises from 5% to 40% by weight of a flame-retardant agent, with respect to the total weight of the composition.

7. The article as defined by claim 1, wherein the intumescent coating comprises an acid source, a carbon source, a blowing agent and a binder.

8. The article as defined by claim 1, wherein the intumescent coating is selected from the group consisting of: an aqueous coating, a glycero coating, a cellulose coating, a vinyl coating, an acrylic coating, a polyurethane coating and an epoxy coating.

9. The article as defined by claim 1, wherein the intumescent coating is a paint or a varnish.

10. The article as defined by claim 1, wherein said article is an extruded or injected article.

11. A process for the manufacture of an article as defined by claim 1, the process comprising applying an intumescent coating over at least one portion of a surface of the article, after having optionally treating the at least one portion of the surface of the article in order to increase adhesion between the at least one portion of the surface and the coating.

12. The process as defined by claim 11, in which the increase in adhesion between the at least one portion of the surface and the coating is brought about by plasma treatment or flame treatment.
